(19) United States
(12) Patent Application Publication
(10) Pub. No.: US 2005/0081252 A1
(43) Pub. Date: Apr. 14, 2005

(54) Device and method for bandwidth optimization using a local cache

(75) Inventors: Thomas E. Chefalas, Somers, NY (US); Steven J. Mastrianni, Unionville, CT (US); Ajay Mohindra, Yorktown Heights, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/686,284

(22) Filed: Oct. 14, 2003

(51) Int. Cl. H04N 7/025; G06F 17/24; G06F 17/21; G06F 17/00; G06F 15/00; H04N 7/16; H04N 7/10

(52) U.S. Cl. 725/135; 725/32; 715/500.1; 715/501.1

(57) ABSTRACT

A device 60 for time-shifting a first signal set with respect to a second signal set, as compared to the time sequence in which they were received, includes a receiver 44B, 46B, a storage means 44C, 46C, 70, a central processing unit 66, and a user interface 72. The first signal set 38 bears a cache marker 34 that directs the CPU to store it in a local storage. The second signal set 40 bears a recall marker 36 that uniquely identifies the first signal set 38 through the cache marker 34, and that determines a sequence in which the first and second signal sets are to be output. The CPU uses the recall marker and cache marker to sequence the first and second signal sets relative to one another in time that differs from the timed relation in which they were received. By storing the first signal set in a local storage, it need be broadcast or transmitted only once, eliminating the need to re-broadcast recurring commercial advertisements and conserving bandwidth.

### FIELD OF THE INVENTION

The present invention relates to methods and apparatus for transmitting, receiving, and displaying to a user disparate sets of signals to optimize bandwidth utilization. More particularly, the present invention stores one signal set in a local memory cache after transmission to time-shift that stored signal relative to another signal set when displayed to a user.

### BACKGROUND

Satellite and wired networks use several techniques to minimize traffic on transmission networks by providing compression and decompression, transcoding, reduced resolution or color depth, or reduced sampling rates for voice or music. While a broadcast is under way, the content is being delivered to a user's television set through a set-top box or a view-on-demand (VOD) system, such as the Tivo® or Replay® devices. (Tivo is a registered trademark of Tivo Inc., and Replay is a registered trademark of Replay Networks, Inc.). These devices generally contain large amounts of storage to allow movies, music, sports, sitcoms, etc. to be recorded and viewed at a later time.

Despite subscription cable and satellite services, advertising in the form of commercials continues to drive revenue for many television stations and networks. Commercials occupy an increasingly large portion of the broadcast time for a particular television show. For example, during a typical sitcom scheduled for thirty minutes of time in a programming schedule, the viewer/user may be shown ten or more minutes of commercials. These commercials are developed and sequenced with entertainment content (e.g., a sitcom) prior to transmission to the user. This sequencing may be by a satellite or cable provider, or by sequenced transmissions from different broadcast towers. This allows the broadcaster, subscription service provider, or affiliate to insert local or content (e.g., local advertiser's commercials or local interest programming) or nationally run commercial advertisements in a planned break in the entertainment content. These commercial advertisements do not change frequently, and the same commercial or public service announcement may run several times during a particular TV show and hundreds of times per day on one or more channels.

Providers of satellite subscription services (TV or radio) are limited in the number of channels that they may provide their subscribers by bandwidth constraints and the transmission capacity of their satellites. Their revenue is driven by the amount of channels they can offer, and many provide upwards of 500 channels. Many of the satellites in current use for television broadcasting purposes operate at or near their capacity limit, leaving the satellite broadcasters with the option of either utilizing bandwidth more efficiently or increasing their satellite broadcasting capacity. Since launching additional satellites is itself expensive and further requires the satellite service provider to obtain rights to additional bandwidth, it is often not a revenue-enhancing option. Cable operators have seen their internet subscribership increase, and their available bandwidth is increasingly occupied by broadband internet traffic. It is expected that this internet traffic will eventually crowd cable television bandwidth, presenting cable television operators with the choice, similar to satellite providers, between increasing bandwidth efficiency or laying additional or replacement cables.

The present invention resolves the above dilemma by enabling more efficient use of transmission. The level of adoption of the present invention affects just how much bandwidth may be conserved, which may then be used for additional channels or other revenue-generating activities by its license holders.

### SUMMARY OF THE INVENTION

This invention provides for a more efficient use of bandwidth and channel allocation by caching sets of cohesive signals that are currently re-transmitted, such as commercial advertisements. The signal sets are stored locally on a user's set-top box or Tivo-like device or other local memory. In one embodiment, commercials are sent to the user's set-top box where they are logged and stored by a cache marker for future retrieval. Later, when a show is being transmitted and a break is about to occur, a recall marker is sent with the entertainment content containing the recall marker that identifies the commercial to play. The recall marker uniquely identifies the cache marker associated with the stored advertisement, which is then sequenced with the entertainment content on the user's television in a manner determined by the recall marker. If the commercial advertisement can't be located in storage, a substitute commercial from the same advertiser is played to ensure that the advertiser's airtime is delivered as expected. At the end of the stored commercial playback, additional transmissions from the service provider are sent to the television.

During the time that the stored advertising or cached signal set is being displayed, the service provider need not occupy spectrum on that channel. The bandwidth normally used for re-transmitting the commercial advertisement is made available for use as another channel. Each signal set to be stored may be organized on the inventive device by an advertiser and product classification as well as the cache marker. In the event that an exact cache marker match to the recall marker is not available, the device may instead substitute a stored commercial from the same advertiser and preferably from the same product classification, assuring that the service provider's commitment for advertising airtime is met.

Specifically, the present invention includes a device for time shifting a first signal set relative to a second signal set. The device includes a receiver, a computer readable storage medium, and a central processing unit CPU. The receiver is for receiving a first cohesive signal set that bears a cache marker at a first time, and for receiving a second cohesive signal set that bears a recall marker at a second time. The CPU is coupled to both the receiver and to the storage medium, and causes the first cohesive signal set to be stored in the storage medium based on the presence of the cache marker. Based on the presence of the recall marker, the CPU accesses the first cohesive signal set via the cache marker that matches at least a portion of the recall marker, and provides an output of the first cohesive signal set in a timed relation to the second cohesive signal set that differs from a timed relation in which said signal sets were received. The recall marker determines the sequence, not the CPU, so the broadcaster originating the transmission retains control over its own broadcast channels and the content provided to its subscribers.

The present invention also includes a method for time-shifting at least one of a plurality of received signal sets. The method includes receiving a first cohesive signal set that bears a cache marker at a first time, and automatically storing the first cohesive signal set in a computer readable storage medium based on the presence of the cache marker. The method further includes receiving a second cohesive signal set bearing a recall marker at a second time, which may be earlier than the first time if the second signal set is also stored in a storage medium. In response to a user request for at least a portion of the second cohesive signal set, the method includes using the recall marker to identify the first signal set bearing the cache marker and outputting the requested portion of the second signal set along with the first cohesive signal set in a timed relation relative to one another. The timed relation of the signal sets that are output in accordance with the method differs from a timed relation in which the respective signal sets were received.

### BRIEF DESCRIPTION OF THE DRAWINGS

The objects, features and advantages of the present invention will be apparent to one skilled in the art, in view of the following detailed description taken in combination with the attached drawings, in which:

FIG. 1A is a diagram showing prior art utilization of bandwidth for television.

FIGS. 1B-C are diagrams showing commercial advertisements (1B) and entertainment content (1C) transmitted separately according to the present invention.

FIG. 2 is a schematic overview of a satellite broadcast communication system in which the present invention may be employed.

FIG. 3 is a schematic overview of a cable broadcast communication system in which the present invention may be employed.

FIG. 4 is a block diagram showing various components of a time shifting device according to the present invention.

### DETAILED DESCRIPTION

While the claimed invention is described below with reference to the figures, a practitioner in the art will recognize the principles of the claimed invention are applicable to other applications including those applications as discussed supra. For purposes of this disclosure, a cohesive signal set is a group of interrelated electronic signals that in combination constitute a human recognizable expression, such as a television show, a time/audio/video portion thereof, an electronically communicated commercial advertisement, an audio recording, and the like. Preferably, a cohesive signal set is one that results in a human recognizable expression lasting at least about fifteen seconds when displayed at a normal or intended rate to a user. The cohesive signal set may comprise individual electronic signals such as bits, symbols, packets, and the like that may be transmitted and/or received at different times and/or over different channels, such as in a spread spectrum transmission technique, and yet remain a cohesive signal set because cohesive refers to the human recognizability of the re-assembled whole. Display herein refers to an audio-visual interface, a visual interface, or an audio interface. For brevity, the term broadcast includes signals sent over publicly available subscriber services such as cable and satellite television service providers, and the term broadcaster includes cable and satellite service providers. For purposes of this disclosure, a television show or entertainment content is a program or portion thereof whose schedule (channel and time) is published to the general viewing public prior to broadcast, such as those explicitly listed in retail programming guides such as TV Guide® or an on-screen listing of programs.

Certain implementation details known in the art, such as digital compression of audio and video files, splicing audio and video components, inserting one cohesive signal set into another cohesive signal set, and satellite transmission transport streams, are described in detail in U.S. Pat. No. 6,029,045, which is herein incorporated by reference in its entirety. The present invention improves over the U.S. Pat. No. 6,029,045 in that the broadcaster of television (or other) content retains control over the sequencing of various pieces of that content by dictating, through an electronic marker embedded in one of the transmitted pieces, the sequence that the pieces of content will be displayed to the end user or viewer. The U.S. Pat. No. 6,029,045 provides that as the set-top box at which local content is stored determines the sequence, based on user preferences or selecting a piece of stored content that fits into a gap in a live transmission. This distinction also allows the sequencing of two pieces of content that are both stored locally, in accordance with the broadcaster's electronic marker that remains stored with one of the pieces.

As an overview of a preferred embodiment, the present invention receives and stores a standard thirty-second television commercial advertisement in a computer readable storage medium. The advertisement includes a cache marker that uniquely identifies it over all other advertisements or other cohesive signal sets stored in the medium. The storage medium may be a read/write hard drive located in a cable or satellite receiver commonly referred to as a television set-top box. At a later time, a user turns on the television and receiver and tunes to a particular channel. This user input is necessarily a request by the user for the television program that corresponds to that time and channel. The receiver receives and outputs the requested television program, which includes an electronic recall marker but no commercials. The receiver reads the recall marker as a command to output the commercial in sequence with the television program, and does so automatically by matching the recall marker to the cache marker.

Where the prior art would broadcast the same commercial advertisement two or three times during the course of a single thirty-minute sitcom, the present invention enables the broadcaster to send the commercial advertisement bearing the cache marker once, and the television program without commercial advertisements but with the additional recall markers. One important distinction between the present invention and prior art time-shifting devices such as TiVo™ and ReplayTV™ is that, in response to a single user request for a television show, the receiver outputs both the requested show and a commercial advertisement that was received separately from the requested show. Considering that the stored advertisement is one cohesive signal set and at least a portion of a television show is another signal set, the present invention time-shifts the two signal sets as displayed relative to one another as compared to the times that they were received. That the commercial advertisement remains stored in a local storage cache after it is first displayed enables the broadcaster to use less bandwidth, while the same exact sequence (as in the prior art) of television program with intermixed commercials is displayed on the user's television. This holds true whether the show being viewed by the user is itself time-shifted as compared to the time it was received, or whether the show is being seen in real time as the broadcaster transmits it.

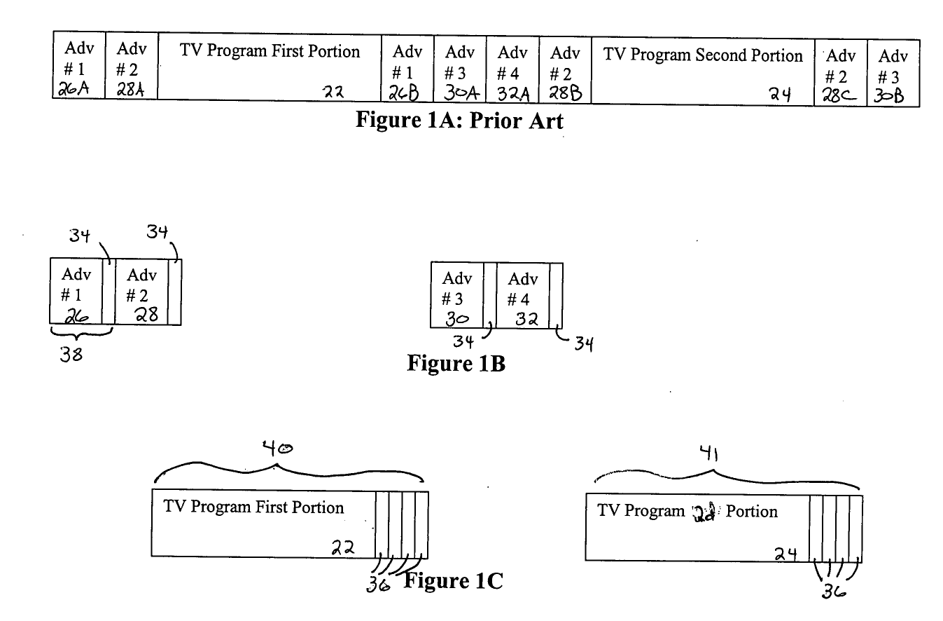

The distinction between bandwidth utilization is illustrated in FIGS. 1A-1C. FIG. 1A represents bandwidth occupied by a prior art broadcast with time along the horizontal axis, representing, for example, a television program that occupies a thirty minute block oftime on one channel. The substance or entertainment content of the television program is parsed by the broadcaster into two cohesive signal sets, a TV program first portion 22 and a TV portion second portion 24. Assume each of the first 22 and second 24 portions occupy ten minutes of broadcast time. The broadcaster transmits those two portions 22,24, in sequenced with various commercial advertisements, which together occupy the balance of the thirty minutes of broadcast time allocated to the TV program in a published schedule such as TV Guide™. Prior to the first portion 22, a first occurrence of a first advertisement 26A is followed by a first occurrence of a second advertisement 28A. Immediately following the first portion 22 is a second occurrence of the first advertisement 26B, a first occurrence of a third advertisement 32A, a fourth advertisement 34, and a second occurrence of the second advertisement 28B. The second portion 24 of the entertainment content is next displayed on a user's television set, followed by a third occurrence of the second advertisement 28C and a second occurrence of the third advertisement 30B. In this prior art approach, each of the first 26, second 28, and third 30 advertisements are broadcast multiple times on a single channel within a relatively short time period.

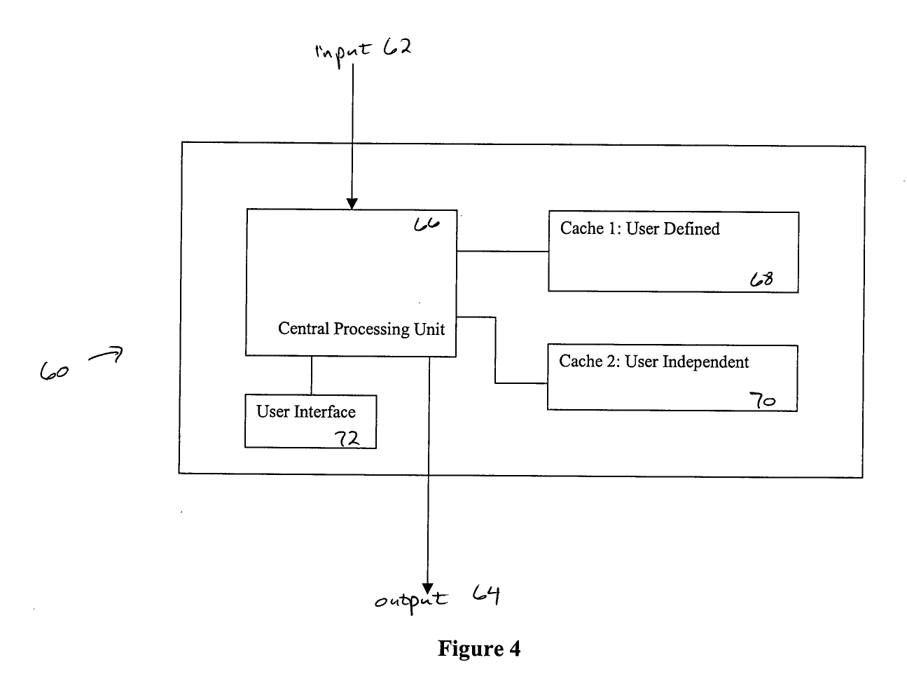

FIG. 1B is a diagram showing only the commercial advertisements 26, 28, 30, 32 being broadcast and received, such as on a channel dedicated to that purpose or at a time not otherwise occupied by programming content, as described below with reference to FIG. 4. In FIG. 1B, each of the advertisements bears a cache marker 34 that uniquely identifies the advertisement to which it is attached. A receiver reads the cache marker 34 as a command to store the advertisement for later access. FIG. 1C is a diagram showing broadcast of the television program similar to that of FIG. 1A. Rather than a continuous broadcast of entertainment content 22, 24 intermixed with recurring advertisements 26, 28, 30, 32, only the content portions 22, 24 are broadcast in FIG. 1C, each bearing one or more recall markers 36 that uniquely match a cache marker 34. The content portions 22, 24 and the advertising portions 26, 28, 30, 34, are intermixed and sequenced at the receiver rather than as the broadcast source, eliminating the need to re-broadcast recurring advertisements 26B-C, 28B, 30B.

In the example of FIG. 1A as compared to FIGS. 1B-1C, the amount of bandwidth preserved is the sum of the advertisements that are re-broadcast in FIG. 1A (26B+26C+28B+30B) less the additional bandwidth occupied by the cache markers 34 and the recall markers 36. In broader terms, each of the advertisements 26, 28, 30, 32, may be a first cohesive signal set 38 and the content portions 22, 24 are a second 40 and a third 41 cohesive signal set, respectively. In the present invention, the first cohesive signal set 38 includes a cache marker 34, and the second 40 and third 41 cohesive signal sets each includes at least one recall marker 36. In the example of FIG. 1B-C, the first occurrence of the first 26A and second 28A advertisement are recalled by a previous TV program (not shown); the second signal set 40 bears recall markers 36 matching cache markers 34 for all four advertisements that immediately follow it (26B, 30A, 32A, 28B of FIG. 1A); and the third signal set 41 bears recall markers 36 for four other advertisements, two of which are shown in FIG. 1A (28C and 30B) and two of which may lead into the next half-hour of scheduled programming similar to advertisements 26A and 28A depicted in FIG. 1A for the present half hour. Though depicted as a non-negligible portion of the signal sets 38, 40, the cache marker 34 and the recall marker 36 need only occupy an insignificant portion of bandwidth as compared to, for example, a thirty second audio-visual commercial advertisement.

Spectrum in the gaps of FIGS. 1B and 1C is not wasted, but rather the entire spectrum is preferably re-apportioned so that no gaps exist, at least not on those channels accessible by users. This re-allocation can be done by contracting the bandwidth dedicated to the channel of FIG. 1C and other such channels, by using a spread spectrum transmission technique that exploits all available bandwidth, or other methods known in the art. Considering that some satellite and cable operators provide numerous channels, and that the same advertisement may be broadcast thousands of times per month across the various channels, the potential for bandwidth conservation is not insignificant.

The cache markers 34 and recall markers 36 may be located at any portion of the respective first 38 and second 40 cohesive signal sets. The recall marker 36 may command a receiver according to the present invention to immediately access and output the advertisement with a corresponding cache marker 34, or to access and output the stored advertisement at a later time (e.g., at the end of the first content portion 22, after a specific time delay, etc.). Such a device may read a series of recall markers 36 and access/output a corresponding series of stored advertisements, or may read one recall marker followed by outputting the corresponding advertisement, read a next recall marker 36 from the second signal set 40 followed by outputting the corresponding advertisement, and so forth. Considering that video signals occupy much more bandwidth than audio, the present invention includes storing, with a cache marker 34, a video component of an advertisement or other cohesive signal set, and transmitting an audio portion tied to another cohesive signal set that includes a recall marker 36, and outputting the stored video component synchronized with the transmitted audio component. The other cohesive signal set to which the audio portion was tied is output in sequence with the audio portion. While this embodiment saves less bandwidth than the preferred embodiment above, it provides an additional measure of quality control in ensuring the disparate signal sets are output to the user's television in the proper order by utilizing audio-visual sequencing already within the signal sets.

While the above paragraphs describe using bandwidth more efficiently by avoiding the need to re-broadcast recurring commercial advertisements, the present invention maybe employed to do the same for any transmission that is frequently re-broadcast under prior art techniques.

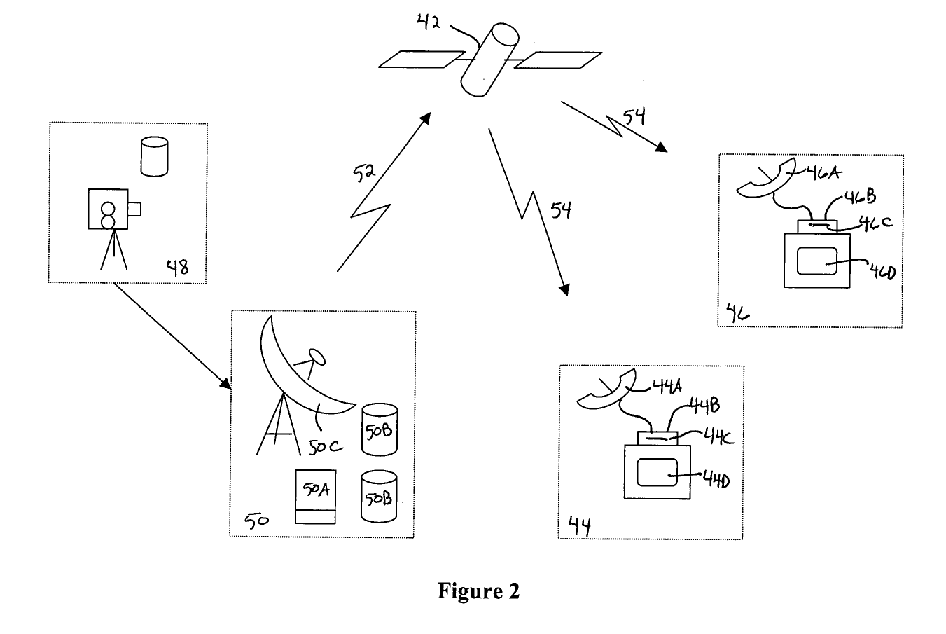

FIG. 2 is an overview of a satellite communication system in which the present invention may be used to advantage. Television transmissions, which includes a mixture of entertainment content and advertising, is transmitted from a satellite 42 to a first user location 44 and to a second user location 46. A first user location 44 includes a satellite receiver dish 44A, associated electronics such as a receiver 44B, a computer readable memory cache 44C, and a display screen 44D. The computer readable memory cache 44C may be any optical, electronic, magnetic, or other computer readable storage medium, and is typically analogous to a computer hard drive having storage sufficient to accommodate hours of audio-visual content in a resolution acceptable to a user. The combination of receiver 44B and memory cache 44C are herein termed a time-shifting device, one that enables a retail user to time-shift their personal viewing of programming content from the time it was received at the user location to a later time. As above, the present invention enables time-shifting of one signal set relative to another as compared to the times that the signal sets were transmitted. The memory cache 44C is preferably located within the same housing as the receiver 44B, or may be disposed within the same housing as the display screen 44D, affixed to the dish 44A, or separately from any or all, such as in a stand alone unit. While the receiver 44B is typically a stand-alone unit, it may alternatively be located within the same housing as the display 44D or built with the dish 44A. The display screen 44D is preferably for providing an audio-video interface to a user, but may alternatively provide only one of audio or video. A second user location 46, not co-located with the first 44, similarly includes a satellite receiver dish 46A, associated electronics such as a receiver 46B, a computer readable memory cache 46C, and a display screen 46D.

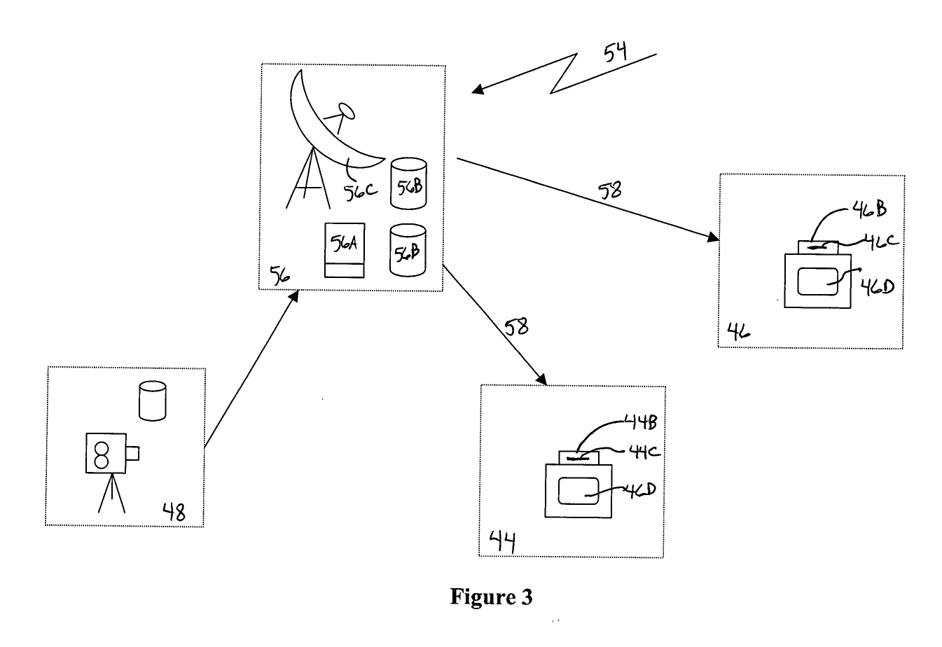

To better describe the advantages and operation of the present invention, FIGS. 2 and 3 presume that the first 44 and second 46 user locations are located within separate local programming areas in which local (non-national) advertising differs from one to the other.

Local programming content, such as local nightly news, community calendars, and commercial advertising spots to be broadcast to only users within a certain geographic limitation, may be produced at a local production studio 48. This local content is typically communicated to a consolidation center 50 that may include mixers 50A for interfacing and sequencing local programming content with non-local or nationally broadcast content, storage arrays 50B for digitally storing such content before and after mixing, and a satellite dish by which the sequenced programming content is communicated via an uplink 52 to the satellite 42 to be broadcast to the users 44, 46 via downlinks 54. Uplinks 52 from various consolidation centers 50 may each individually provide programming content to the satellite 42 subject to synchronization either on the ground or at the satellite, or to storage means at the satellite 42. The downlink channels 54 may include locally broadcast channels W and X, and nationally broadcast channels Y and Z, for example. The receiver 44C of the first user 44 may be tuned to receive all of the national channels and local channel W, but not local channel X, due to the location of the first user 44. Conversely, the receiver 46C of the second user 46 may be tuned to receive all of the national channels and local channel X, but not local channel W, due to the different location of the second user 46.

Alternative to the satellite 42 and dish 44A is a cable broadcast system shown schematically in FIG. 3. The first user location 44 and second user location 46 may each receive its television programming content from one or more cable distribution centers 56. In this instance, the time shifting device comprises the receiver 44B or 46B, and the memory cache 44C or 46C, and the television programming content is provided thereto via a coaxial cable 58. The cable distribution center 56 may include equipment such as a mixer 56A to interface and sequence disparate programming content as described above, various storage arrays 56B to accumulate content from several sources and arrange the various content according to a schedule, and one or more reception means such as a coaxial cable 58 to receive local programming from a local production facility 48 and a satellite receiver 56C to receive programming via a wireless downlink 54, which may be a satellite downlink or an air interface. The cable distribution center 56 then broadcasts content to the first user location 44 via a coaxial cable 58 or other suitable communication means to the first 44 and second 46 users. A single cable distribution center 56 may provide programming content to only one or to more than one local programming area. Where a single cable distribution center 56 serves disparate local programming areas, a local channel for a first user 44 may be provided to all users 44, 46 within the area served by the cable distribution center 56, and selectively filtered at the various receivers 44B, 46B, or not tuned to receive the local channels that do not apply to the particular local area of the respective user location 44, 46, similar to the satellite communications system of FIG. 2. In each of FIGS. 2 and 3, entertainment content and commercial advertising is sequenced prior to transmission by the above or other means. The present invention allows the sequence to be determined prior to transmission using the recall markers, but the actual sequencing to be done locally at the user's location.

Following is described how the signal sets bearing the cache markers may be communicated to the receiver. Assume a source 42, 56 provides programming according to the prior art along four channels, W, X, Y, and Z. Each channel according to the prior art would be continuously occupied with transmissions/broadcasts for that channel in order that a receiver 44B, 46B tuned to that channel would provide uninterrupted content to the associated display 44D, 46D. In the prior art, gaps in bandwidth utilization for any particular channel would result in a blank screen on the display 44D, 46D for the duration of the gap.

Assume further that channels Y and Z are nationally broadcast, so their programming content is sequenced in total by a single source such as the channel operator (e.g., CBS®, ESPN®). Rather than sequencing the actual content, these channel operators merely provide matching cache markers and recall markers to the appropriate signal sets, and provide only the entertainment content wherein signal sets bear the recall markers over their channel during the previously scheduled times. The advertising, wherein signal sets bear the cache markers, is provided to the transmitting source 42, 56, and transmitted over a channel dedicated to signal sets bearing cache markers. Alternatively, the channel operators may provide the signal sets bearing cache markers en masse at times the channel is not operational (for non-24 hour channels). The inventive device is programmed to monitor the dedicated channel, or to continuously scan the national and relevant local channels at frequent time intervals, to detect the presence of a cache marker or other similar command, and retain the associated signal set in storage.

Channels W and X are local channels serving different local areas, and so both the entertainment content and the advertising differs between them. In some instances, a channel may be local at certain times of the day wherein programming is sequenced by a local operator (e.g., local news broadcast by a network affiliate on a network channel) and a national channel at other times (network broadcasts), or a channel may be local only (e.g., community television). For the local only channels, each user's receiver selectively receives only the relevant local channels and not those of other local areas. Local channels carry both nationally run advertisements and local only advertisements, so program sequencing is done in two stages, and wither may precede the other. In one stage, the local channel operator sequences in their local channel W or X the nationally run advertising that is provided to them by a network with which the local channel may be affiliated. In a second stage, the local channel operator sequences into the remaining time other local only advertising, such as for local auto dealers. Whether the local feed provides a feed to the transmitting source 42, 56, or broadcasts itself over locally based towers, the local channel operator need only add the recall markers to the entertainment content that it initiates. It may provide the advertisements bearing the cache marker 34, as provided by a production studio 48, to the source 42, 56, over its regular air-interface channel via the local transmission tower at a time not otherwise used for broadcast, or over a separate air interface channel at any time.

Advertisers will likely desire to change their commercials from time to time. The cache marker 34 may contain a priority code such as a date/time stamp, so that a receiver recognizing a re-broadcast of an advertisement already stored will not store another copy of the same advertisement, but that same receiver recognizing only a changed priority code will store the higher priority version of the advertisement and delete the lower priority version to preserve memory.

FIG. 4 is a simplified block schematic diagram showing a device 60 according to a preferred embodiment of the present invention having an input 62 by which signal sets are received and an output 64 to a display 44D, 46D. The input may be from the source 42, 56, or from a separate receiver 44B, 46B. The input feeds into a central processing unit CPU 66 that recognizes the cache marker 34 or recall marker 36 of the signal set, as the case may be. Assuming the device 60 includes time shifting of entertainment content as in the prior art, the CPU stores a television program requested by the user via a user interface 72, as transmitted, in a user defined cache 68. The device receives further signal sets independent of the user, preferably even when the user has switched the device off but the device remains powered. The CPU 66 searches the cache markers of signal sets, and if a cache marker 34 does not identically match a cache marker already in storage, the CPU stores that signal set and cache marker in a user independent cache 70. The user dependent 68 and user independent 70 caches maybe the same physical storage means such as an optically readable disc, but are depicted separately for clarity of explanation. At some time after storing the advertisement bearing the cache marker, the user requests, via the user interface 72 such as tuning to a particular channel at a particular time, to view a television program. Assuming no additional user inputs such as changing the channel or turning off the device 60 or receiver, the CPU outputs the requested entertainment content, which itself includes the recall markers, in sequence with one or more advertisements that bear cache markers identified by the recall markers. Whether the requested entertainment content is viewed in real time as transmitted, or from the user defined cache 68, the first signal set is time shifted relative to the second signal set as compared to the times that the respective signal sets were received. The first signal set bearing the cache marker remains in the user independent cache 70 for additional outputting to the display until replaced, such as by an advertisement bearing a higher priority code.

Each of the first and second signal sets may begin and/or end with a marker that signals a transition between them. For example, a first signal set bearing a cache marker may lead with the cache marker for rapid identification of the first signal set in storage, and end with a transition marker that directs the CPU to next sequence the user's requested program, which is the second signal set. The second signal set may bear the recall marker at any location so long as the CPU has sufficient time to search for the matching cache marker or a matching sponsor identifier in storage. The next signal set from storage that bears a cache marker again directs the CPU back to the user's requested signal set, and so forth. While there has been illustrated and described what is at present considered to be a preferred embodiment of the claimed invention, it will be appreciated that numerous changes and modifications are likely to occur to those skilled in the art. It is intended in the appended claims to cover all those changes and modifications that fall within the spirit and scope of the claimed invention.

1. A device for time shifting a first cohesive signal set relative to a second cohesive signal set comprising:
a receiver for receiving a first cohesive signal set comprising a cache marker at a first time and a second cohesive signal set comprising a recall marker at a second time;
a computer readable storage medium;
a central processing unit CPU coupled to the receiver and to the storage medium, said CPU for storing the first cohesive signal set in the storage medium based on the presence of the cache marker, for accessing the first cohesive signal set based on the presence of the recall marker, and for providing an output of the first cohesive signal set in a timed relation to the second cohesive signal set that differs from a timed relation in which said signal sets were received, said timed relation determined by the recall marker.

2. The device of claim 1 wherein said output comprises one of the first and second cohesive signal set consecutive with the other of the first and second signal set.

3. The device of claim 1 wherein the first cohesive signal set comprises one of an audio and a video portion of a commercial advertisement.

4. The device of claim 3 wherein said first cohesive signal set comprises a video component of a commercial advertisement and said second cohesive signal set comprises an audio component of said commercial advertisement and at least a portion of a television show, and wherein said sequenced relation results from synchronizing said video component with said audio component.

5. The device of claim 1 wherein the receiver is further for receiving a third cohesive signal set comprising the recall marker at a third time, and wherein said output comprises one instance of the second and third cohesive signal sets and at least two instances of the first cohesive signal set.

6. The device of claim 1 wherein the first cohesive signal set is received over a first channel and the second cohesive signal set is received over a second channel.

7. The device of claim 1 wherein said CPU outputs the second cohesive signal set as it is received by the receiver.

8. The device of claim 1 wherein, based on a user input, said CPU stores said second cohesive signal set in a computer readable memory and provides said output at a time subsequent to each of said first time and said second time.

9. The device of claim 8 wherein said first and second cohesive signal sets are stored on a common computer readable storage medium.

10. The device of claim 1 wherein said recall marker uniquely identifies the cache marker over other signal sets in said storage medium.

11. The device of claim 1 wherein each of said cache marker and said recall marker each further comprise a sponsor identifier, said recall marker does not uniquely identify said cache marker apart from the sponsor identifier, and said CPU accesses the first cohesive signal set based on the presence of the sponsor identifier in the recall marker.

12. The device of claim 1 wherein said cache marker further comprises a priority code that directs said CPU to store said first signal set and delete another signal set bearing a similar cache marker comprising a lower priority code.

13. A method for time-shifting at least one of a plurality of received signal sets, comprising:
receiving a first cohesive signal set comprising a cache marker at a first time;
based on the presence of the cache marker, automatically storing said first cohesive signal set in a computer readable storage medium;
receiving a second cohesive signal set comprising a recall marker at a second time; and
in response to a user request for the second cohesive signal set, using the recall marker to identify the cache marker of the first signal set and outputting the requested second signal set and the first cohesive signal set in a timed relation relative to one another that differs from a timed relation in which they were received, wherein the output timed relation is determined by the recall marker.

14. The method of claim 13 wherein said received timed relation is at least two orders of magnitude greater than said output timed relation.

15. The method of claim 13 wherein said first signal set and said second signal set are received over different channels.

16. The method of claim 13 wherein outputting said portion comprises outputting said portion as received without storing said portion.

17. The method of claim 13 wherein each of said cache marker and recall marker further comprises a sponsor identifier, and using the recall marker to identify the first signal set comprising the cache marker includes matching said sponsor identifier.

18. The method of claim 13 wherein said cache marker further comprises a priority code that directs said CPU to store said first signal set and delete another signal set bearing a similar cache marker comprising a lower priority code.

19. In a device comprising a receiver for receiving a plurality of signal sets, a central processing unit CPU, and a computer readable storage means, the improvement comprising:
means for storing at least a first signal set bearing a cache marker, and in response to a user request for a second signal set, means for outputting the first and second signal set in a timed relation that is unrelated to a timed relation in which they were received at the receiver and that is determined by the second signal set.

20. A computer program embodied on a computer readable medium comprising computer readable instructions for:
recognizing a cache marker within a first signal set received at a first time, and storing the first signal set;
recognizing a recall marker within a second signal set received at a second time, and accessing the first signal set based on at least a partial correlation between the recall marker and the cache marker;
outputting the first signal set in a timed relation relative to the second signal set that is independent of a timed relation in which the signal sets were received.

21. A method of sequencing at least two disparate signal sets comprising:
transmitting a first signal set at a first time, said first signal set including an electronic cache marker and an electronic instruction to the local storage cache to retain said first signal set in a local cache;
transmitting a second signal set at a second time, said second signal set including an electronic recall marker that uniquely identifies the cache marker of the first signal set and that directs a receiver to sequence said first signal set with said second signal set when said second signal set is output from the receiver.

22. The method of claim 21 wherein transmitting is over a wireless link.

23. The method of claim 22 wherein said transmitting is over a cable link.
